(19) United States
(12) Patent Application Publication
(10) Pub. No.: US 2009/0178314 A1
(43) Pub. Date: Jul. 16, 2009

(54) Electronic shelf label attachment mechanism with height adjustment

(75) Inventor: Long Van Nguyen, San Jose, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Networks, Inc.

(21) Appl. No.: 12/008,514

(22) Filed: Jan. 11, 2008

(51) Int. Cl. G09F 9/00

(52) U.S. Cl. 40/446

(57) ABSTRACT

An electronic shelf label (ESL) system for attachment to a shelf and a universal attachment mechanism is disclosed. In accordance with the purpose of this invention, as embodied and broadly described herein, the invention is an ESL system for attachment to a C-channel type shelf that comprises a large ESL having a body housing a display on the front side and a plurality of catches formed at different heights on the rear side, wherein the body of the large ESL is releasably coupled to an adapter mounted to the C-channel type shelf using a catch of the plurality of catches, thus can be mounted at different heights.

### FIELD

The present disclosure relates to electronic shelf labels (ESLs) and, more particularly, to systems and methods that facilitate installment and removal of ESLs to and from retail store shelves.

### BACKGROUND

Electronic shelf labels (ESLs) are being used in retail stores and, in particular, large retail stores. ESLs are replacing traditional paper and plastic labels for their improved maintainability and the ease of price and information updates. Currently, shelves at retail stores are designed to display the traditional paper and plastic tags. ESLs are typically larger and heavier than the paper and plastic tags they replace, and the existing retail store shelves have different types and sizes of hooks or mounting surfaces. ESLs are currently available in two major sizes: small (e.g., 1″ by 2″ or 1″ by 3″) and large (e.g., 3″ by 7″ or 4″ by 6″). Large ESLs are often referred to as Produce or End Cap ESLs. Small ESLs are typically mounted at a fixed position flushed below the shelf surface. However, large ESLs do not follow any strict guideline, especially when mounted on a C-channel shelf and mounting position is determined by the store's layout scheme and personal preference. Once mounted on a shelf, it would be difficult to change positions of the ESLs without changing the attachment mechanism designed for the particular shelves. In light of those disadvantages, there is a need for an attachment mechanism for large ESLs that is height- and position-adjustable, thereby providing a flexible configuration to display ESLs without replacing the hardware of the existing shelves.

### SUMMARY

An electronic shelf label (ESL) system for attachment to a shelf using a universal attachment mechanism is disclosed.

In accordance with the purpose of the various embodiments described herein, as embodied and broadly described herein, the subject matter of this patent relates to an ESL system for attachment to a C-channel type shelf that comprises a large ESL having a body housing a display on the front side and a plurality of catches formed at different heights on the rear side, wherein the body of the large ESL is releasably coupled to an adapter mounted to the C-channel type shelf using a catch of the plurality of catches, thus it can be mounted at different heights.

The above and other preferred features, including various novel details of implementation and combination of elements will now be more particularly described with reference to the accompanying drawings and pointed out in the claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE DRAWINGS

FIG. 1A is a front-oriented perspective view of a first exemplary attachment mechanism for a large ESL.

FIG. 1B is a rear-oriented perspective view of the first exemplary attachment mechanism for a large ESL.

FIG. 2A is a front-oriented perspective view of a second exemplary attachment mechanism for a large ESL.

FIG. 2B is a rear-oriented perspective view of the second exemplary attachment mechanism for a large ESL.

FIG. 3 is a front-oriented perspective view of an adapter for an ESL mounted to a C-channel shelf.

FIG. 4A is a front-oriented perspective view of a large ESL with the first exemplary attachment mechanism mounted at a first height.

FIG. 4B is a front-oriented perspective view of a large ESL with the first exemplary attachment mechanism mounted at a second height.

FIG. 4C is a rear-oriented perspective view of a large ESL with the first exemplary attachment mechanism mounted at the first height.

FIG. 4D is a rear-oriented perspective view of a large ESL with the first exemplary attachment mechanism mounted at the second height.

FIG. 4E is a side-oriented view of a large ESL with the first exemplary attachment mechanism mounted at the first height.

FIG. 4F is a side-oriented view of a large ESL with the first exemplary attachment mechanism mounted at the second height.

FIG. 4G is a front-oriented explosive view of a large ESL with the first exemplary attachment mechanism.

FIG. 4H is a rear-oriented explosive view of a large ESL with the first exemplary attachment mechanism.

FIG. 5A is a front-oriented perspective view of a large ESL with the second exemplary attachment mechanism mounted at a first height.

FIG. 5B is a front-oriented perspective view of a large ESL with the second exemplary attachment mechanism mounted at a second height.

FIG. 5C is a front-oriented perspective view of a large ESL with the second exemplary attachment mechanism mounted at a third height.

FIG. 5D is a front-oriented perspective view of a large ESL with the second exemplary attachment mechanism.

FIG. 5E is a rear-oriented perspective view of a large ESL with the second exemplary attachment mechanism.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

Each of the additional features and teachings disclosed herein can be utilized separately or in conjunction with other features and teachings to provide a height-adjustable attachment mechanism for large ESLs. Representative examples utilizing many of these additional features and teachings, both separately, and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Electronic shelf labels (ESLs) are increasingly replacing conventional paper and plastic tags for the improved maintainability and the ease of price and information updates for products displayed in retail stores. Prices and product information continually change, and creating new price and product information tags and replacing them on numerous retail store shelves require human labor that adds extra cost for buyers. Recent development in technology enabled retailers to use ESLs that provide many features that the conventional paper and plastic tags lack. When equipped with a wireless receiver, ESLs can update price and information at a much lower cost in shorter time. More frequent updates are possible at virtually no additional cost. In-depth information about a product can be provided to the buyers including nutritional information, expiration dates, source of the product, etc. Even multimedia and/or interactive content can be provided for a richer user experience.

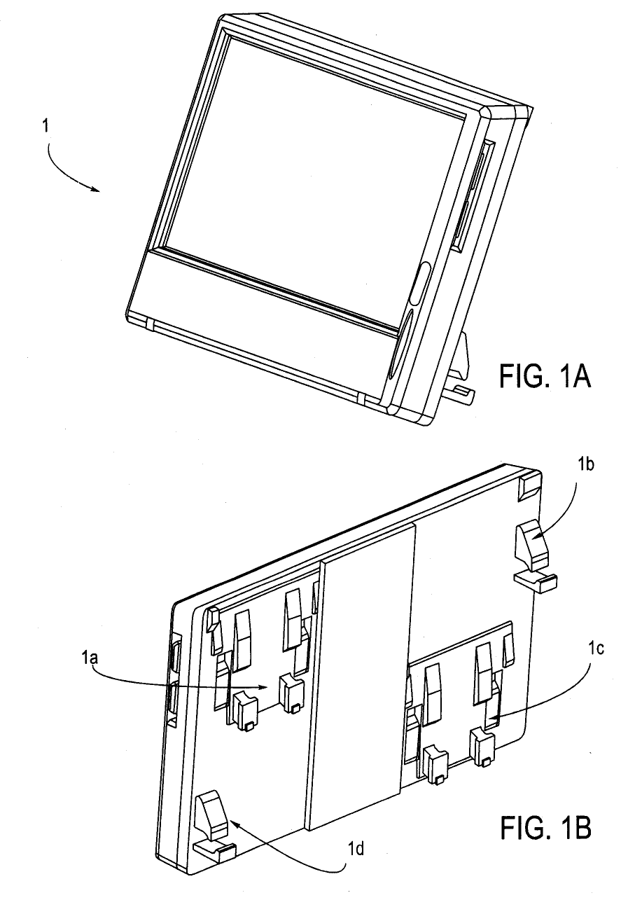

FIG. 1A is a front-oriented perspective view of a first exemplary attachment mechanism for a large ESL, according to one embodiment. ESL 1 has a display area for displaying price and product information. The large ESL 1 is interchangeably called ESL 1 hereinafter. The relative size of the large ESL, e.g., 3″ by 7″ or 4″ by 6″, may change over time and being large by current standards may eventually no longer considered large. ESL 1 may also have other features such as a power on/off button, wireless tag and antenna to communicate with a transmitter, peripherals, storage medium, etc. FIG. 1B is a rear-oriented perspective view of the first exemplary attachment mechanism for the large ESL 1. According to one embodiment, the attachment mechanism for a large ESL 1 is formed on the rear side of the large ESL so that it is a part of the large ESL 1. According to another embodiment, the attachment mechanism for a large ESL 1 is a separate piece so that it can be attached or detached to the rear side of the large ESL. For this case, the attachment mechanism includes the patterns 1a-1d. Depending on the manufacturing cost and other design factors, an appropriate solution will be chosen. For the convenience of illustration, the former option of the attachment mechanism for a large ESL is shown, and those skilled in the art will recognize the latter option of the attachment mechanism can easily substitute the exemplary attachment mechanisms that will be discussed hereinafter.

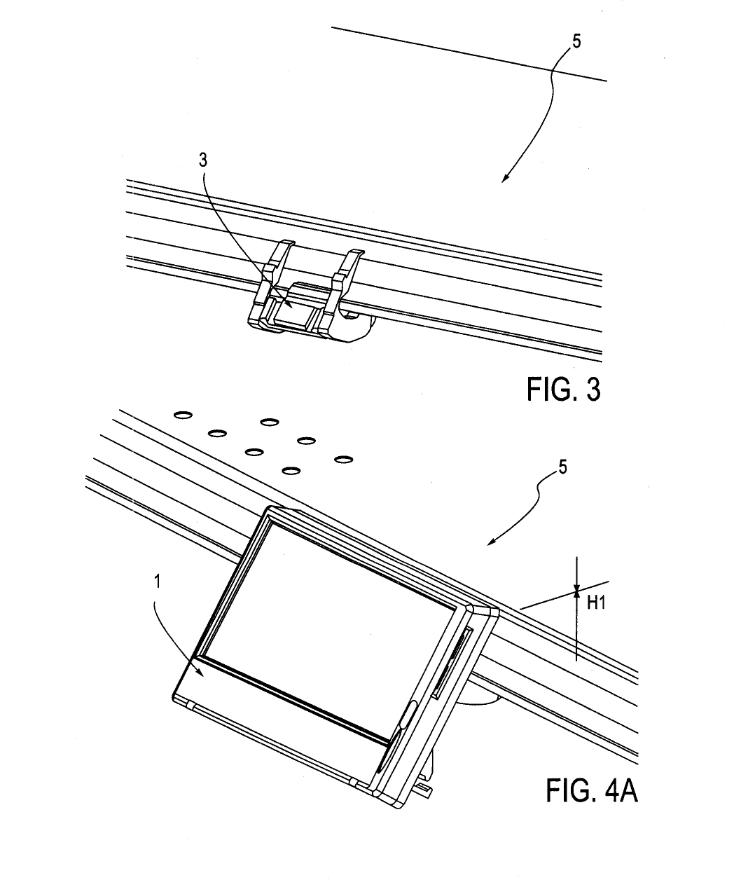

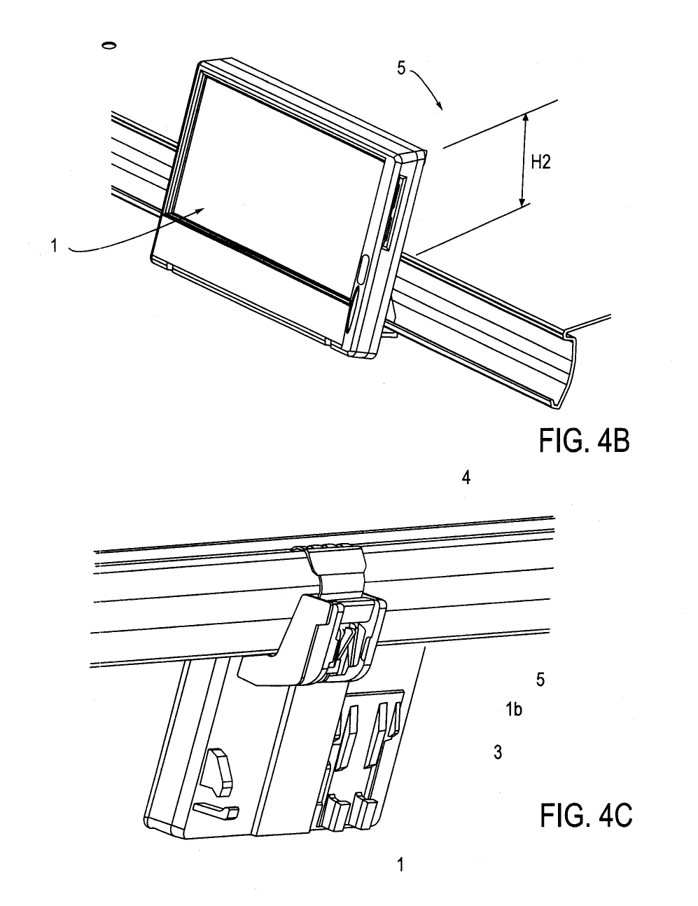

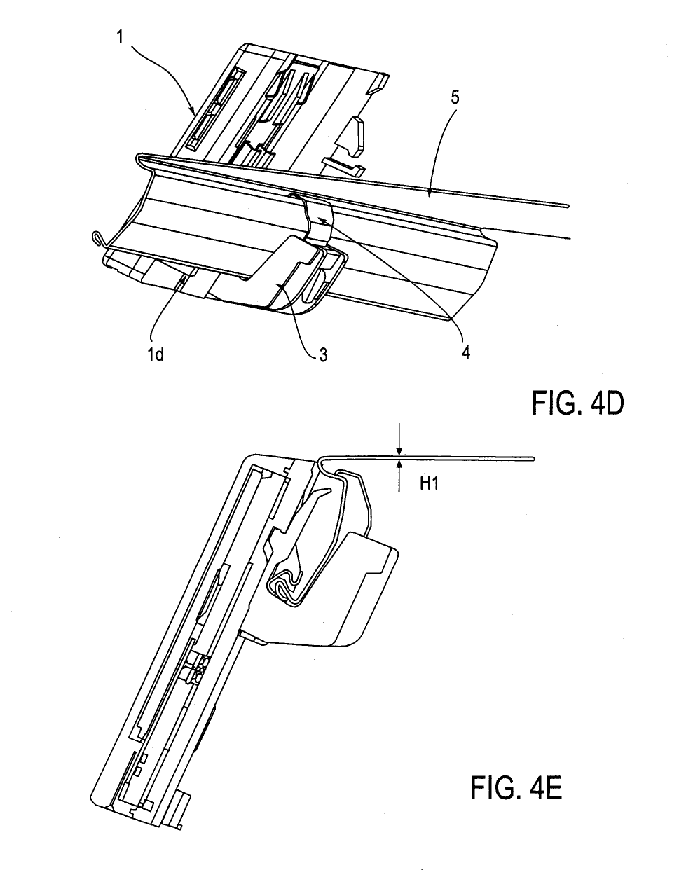

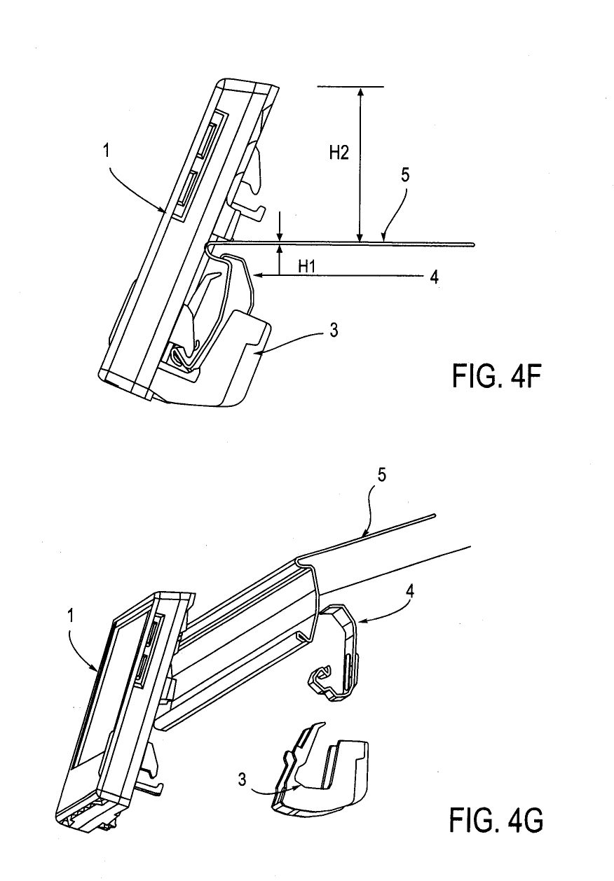

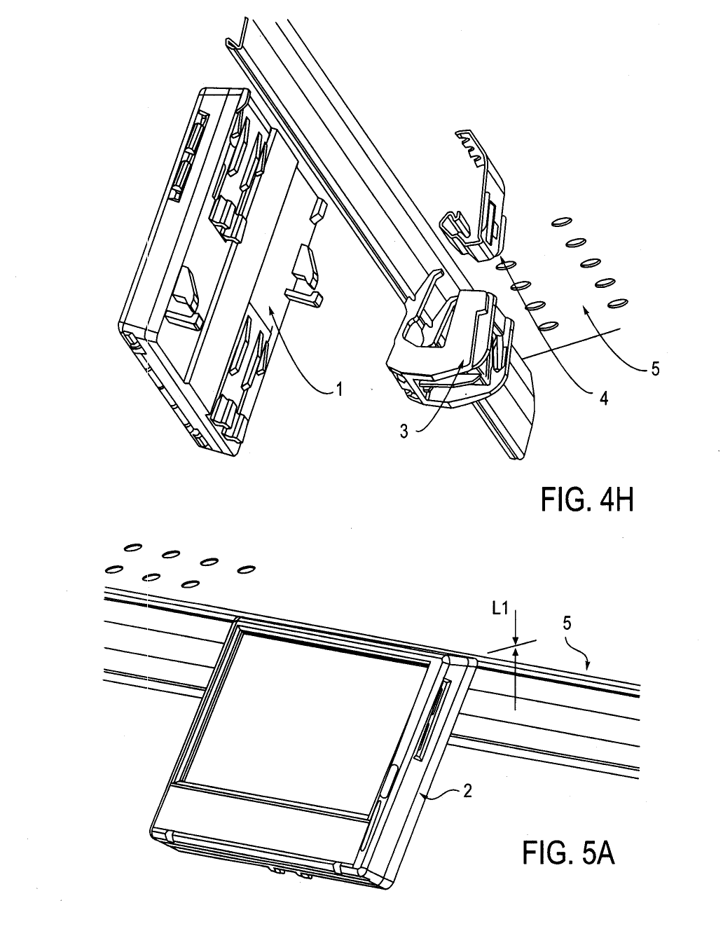

According to one embodiment, the first exemplary attachment mechanism for a large ESL 1 has two mounting positions, 1a and 1c. The details of the C-channel shelf adapter 3 of FIG. 3 is explained in a separate U.S. patent application Ser. No. 11/780,103, entitled “Behind C-Channel Shelf Attachment Mechanism” and filed on Jul. 19, 2007. U.S. patent application Ser. No. 11/780,103 is hereby incorporated by reference herein its entirety. The C-channel shelf adapter 3 has two keyways and two releasable mounting arms. Using the two keys and two indentations on 1a and 1c, the large ESL 1 is mounted on the C-channel shelf adapter 3. The large ESL I has additional catches 1b and 1d disposed on the rear surface of ESL 1 such that they are opposite to catches 1a and 1c, which allows for greater stability. Since the center of gravity 1 is off the center of the mounting pivot points when mounted at either 1a and 1c, the large ESL 1 is subject to a rotational moment causing it to tilt. Catches 1b and 1d on the other end grasp the C-channel shelf to prevent the large ESL 1 from tilting as illustrated in FIGS. 4C and 4D.

Although FIG. 1B shows two mounting positions, 1a and 1c, those skilled in the art will recognize that more mounting locations can be formed on the large ESL 1 if required and spatially allowable. The catches 1b and 1d are shown as permanent patterns on the large ESL 1, however they may be releasably attached to the rear side of the large ESL 1 as well. The mounting locations 1a and 1c may be reconfigured so that 1a and 1c are on the same side or the opposite side.

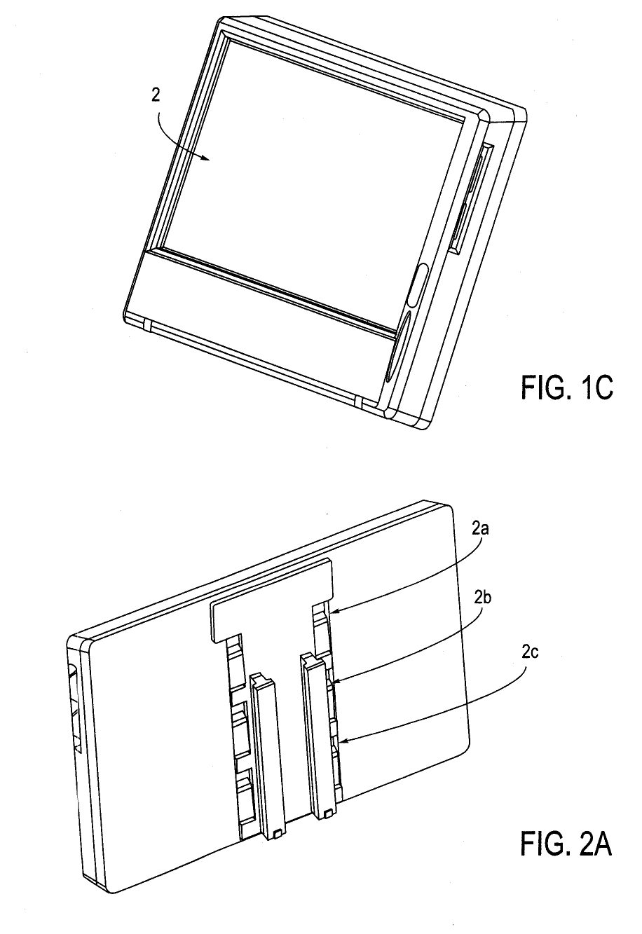

FIG. 2A is a front-oriented perspective view of a second exemplary attachment mechanism for a large ESL 2. FIG. 2B is a rear-oriented perspective view of the second exemplary attachment mechanism for the large ESL 2. The second exemplary attachment mechanism has three vertically aligned mounting locations, 2a, 2b and 2c, at the rear center of the large ESL 2. Each mounting position shares the two long keys and indentation patterns similar to the first exemplary attachment mechanism of FIG. 1. FIG. 2B shows only three mounting locations, 2a-2c; however, those skilled in the art will easily recognize that any number of mounting locations can be formed if required and spatially allowable. Instead of being aligned at the rear center, the mounting locations 2a-2c may be moved to the sides as shown in FIG. 1B with or without additional catches similar to 1b and 1d. It is also possible to have two or more rows of mounting locations to be able to adjust mounting heights as well as mounting locations (left or right).

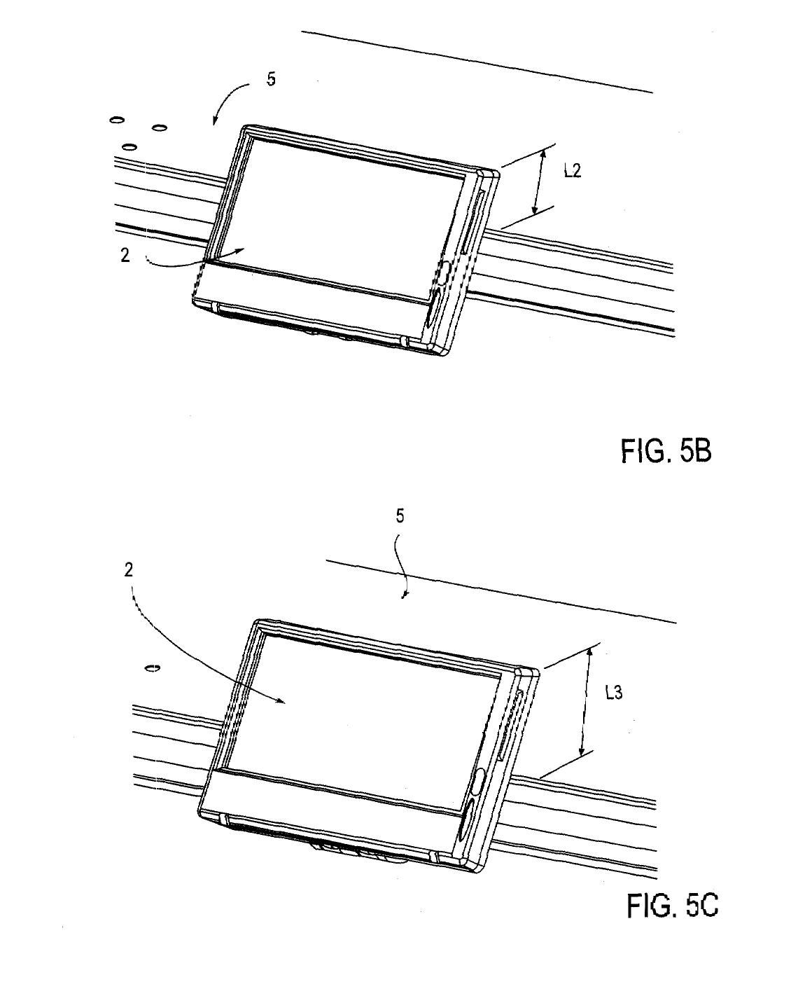

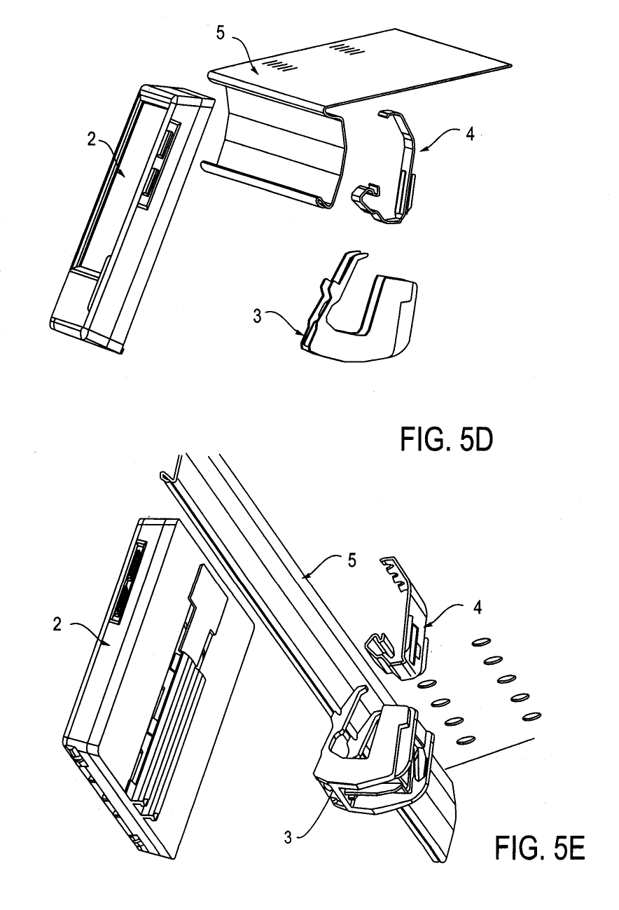

FIG. 3 is a front-oriented perspective view of a shelf adapter 3 mounted to a C-channel shelf 5. The shelf adapter 3 is coupled to a spring clip 4 to securely mount to the C-channel shelf 5 as shown in FIGS. 4C, 4G, 4H, 5D and 5E. The spring clip 4 has jaws on the top to catch the top of the “C”-shaped holder of C-channel shelf 5 from behind. The lower end of the spring clip 4 curves around the bottom end of the “C”-shaped holder of C-channel shelf 5, discouraging the spring clip 4 from coming loose. The shelf adapter 3 has a channel to releasably receive the body of the spring clip 4 and one or more latches that releasably engage the one or more catches formed in the body of the spring clip 4.

FIG. 4A is a front-oriented perspective view of the large ESL 1 with the first exemplary attachment mechanism mounted at a first location 1a. The top side of the large ESL 1 is flush just below the surface of the C-channel shelf 5. The distance H1 measured from the top side of the large ESL 1 to the surface of the shelf 5 is close or equal to zero. FIG. 4C is a rear-oriented perspective view of the large ESL 1 mounted at the first location 1a. The catch 1b is holding the large ESL 1 in position and preventing it from tilting due to the offset of the center of gravity. FIG. 4E is a side-oriented view of the large ESL 1 with the first exemplary attachment mechanism mounted at the first location 1a.

FIG. 4B is a front-oriented perspective view of the large ESL 1 with the first exemplary attachment mechanism mounted at a second location 1c. The distance H2 measured from the top side of the large ESL 1 to the surface of the shelf 5 is bigger than H1 so that the large ESL 1 stands higher than the first location 1a. FIG. 4D is a rear-oriented perspective view of the large ESL 1 mounted at the second location 1c. The catch 1d is holding the large ESL 1 in position and preventing it from tilting due to the offset of the center of gravity. FIG. 4F is a side-oriented view of a large ESL with the first exemplary attachment mechanism, mounted at the second location 1c.

FIG. 4G is a front-oriented explosive view of the large ESL 1 with the first exemplary attachment mechanism. FIG. 4H is a rear-oriented explosive view of the large ESL 1 with the first exemplary attachment mechanism.

FIG. 5A is a front-oriented perspective view of the large ESL 2 with the second exemplary attachment mechanism mounted at a first height 2a. The top side of the large ESL 2 is flush just below the surface of the shelf 5. The distance L1 measured from the top side of the large ESL 2 to the surface of the shelf 5 is close or equal to zero. FIG. 5B is a front-oriented perspective view of the large ESL 2 with the second exemplary attachment mechanism mounted at a second height 2b. The distance L2 measured from the top side of the large ESL 2 to the surface of the shelf 5 is bigger than L1 so that the large ESL 2 stands higher than the first location 2a. FIG. 5C is a front-oriented perspective view of the large ESL 2 with the second exemplary attachment mechanism mounted at a third height 2c. The distance L3 measured from the top side of the large ESL 2 to the surface of the shelf 5 is bigger than L2 so that the large ESL 2 stands higher than the first location 2b.

FIG. 5D is a front-oriented perspective view of the large ESL 2 with the second exemplary attachment mechanism. FIG. 5E is a rear-oriented perspective view of the large ESL 2 with the second exemplary attachment mechanism.

The attachment mechanism for a large ESL provides multiple height positions and multiple locations for displaying price and product information without replacing the hardware of the existing shelves.

We claim:

1. An electronic shelf label (ESL) system for attachment to a C-channel type shelf comprising:
a clip having a body with first and second opposing jaws that engage the top and bottom of a C-shaped holder of the C-channel shelf to fix the clip relative to the C-channel shelf;
an adapter having a channel to releasably receive the body of the clip and a latch that releasably engages a first catch formed in the body of the clip; and
an electronic shelf label (ESL) comprising a body with a front surface and a rear surface opposing the front surface, the ESL housing a display exposed on the front surface of the ESL, the ESL further comprising a plurality of second catches formed at different heights on the rear surface, the body of the ESL being releasably coupled to the adapter using at least one catch of the plurality of second catches.

2. The ESL system of claim 1 wherein at least one catch of the plurality of second catches is positioned substantially at a first end of the rear surface of the ESL.

3. The ESL system of claim 2 wherein the ESL has a plurality of third catches positioned substantially at a second end of the rear surface of the ESL, wherein the plurality of third catches grasps the C-channel type shelf to prevent the ESL from tilting.

4. The ESL system of claim 1 wherein the plurality of second catches of the ESL comprises one or more keys and one or more indentations, and wherein the adapter has one or more keyways to accept the one or more keys of the ESL and one or more mounting arms to releasably engage the one or more indentations of the ESL.

5. The ESL system of claim 1 wherein the plurality of second catches is vertically aligned at a substantially central location on the rear surface of the ESL.

6. The ESL system of claim 5 wherein the plurality of second catches of the ESL comprises one or more keys and one or more indentations, and wherein the adapter has one or more keyways to accept the one or more keys of the ESL and one or more mounting arms to releasably engage the one or more indentations of the ESL.

7. The ESL system of claim 6 wherein the plurality of second catches of the ESL shares the one or more keys.

8. An ESL for attaching to a C-channel type shelf comprising:
a body housing a display exposed on a front surface; and
a plurality of first catches formed at different heights on a rear surface of the body,
wherein the body of the ESL is releasably coupled to an adapter mounted to the C-channel type shelf using at least one catch of the plurality of first catches.

9. The ESL of claim 8 wherein at least one catch of the plurality of first catches is positioned substantially at a first end of the rear surface of the ESL.

10. The ESL of claim 9 wherein the ESL has a plurality of second catches positioned substantially at a second end of the rear surface of the ESL, wherein the plurality of second catches grasps the C-channel type shelf to prevent the ESL from tilting.

11. The ESL of claim 8 wherein the plurality of first catches of the ESL comprises one or more keys and one or more indentations, and wherein the adapter has one or more keyways to accept the one or more keys of the ESL and one or more mounting arms to releasably engage the one or more indentations of the ESL.

12. The ESL of claim 8 wherein the plurality of first catches is vertically aligned at a substantially central location on the rear surface of the ESL.

13. The ESL of claim 12 wherein the plurality of first catches of the ESL comprises one or more keys and one or more indentations, and wherein the adapter has one or more keyways to accept the one or more keys of the ESL and one or more mounting arms to releasably engage the one or more indentations of the ESL.

14. The ESL of claim 13 wherein the plurality of first catches of the ESL shares the one or more keys.
